(19) United States
(12) Patent Application Publication
(10) Pub. No.: US 2016/0330435 A1
(43) Pub. Date: Nov. 10, 2016

(54) THREE-DIMENSIONAL DISPLAY DEVICE USING FLUORESCENT MATERIAL

(71) Applicant: EMPIRE TECHNOLOGY DEVELOPMENT LLC, Wilmington, DE (US)

(72) Inventor: Eiji YAMAICHI, Tokyo (JP)

(73) Assignee: EMPIRE TECHNOLOGY DEVELOPMENT LLC, Wilmington, DE (US)

(21) Appl. No.: 15/108,322

(22) PCT Filed: Dec. 31, 2013
(86) PCT No.: PCT/US2013/078564

§ 371 Date: Jun. 27, 2016

(51) Int. Cl. H04N 13/04

(52) U.S. Cl. CPC H04N 13/0495; H04N 13/0427; H04N 13/0497

(57) ABSTRACT

Technologies are generally described for displaying a three-dimensional image of an object. In various examples, a display device is described, where the device may generate a first light beam from a first light source based on a first input signal indicative of the object. The device may receive the first light beam on a first display panel including one or more fluorescent materials effectively to form a first image of the object due to fluorescence from the first display panel in response to the first light beam. The device may also generate a second light beam from a second light source based on a second input signal indicative of the object. A second display panel including one or more fluorescent materials may receive the second light beam effectively to form a second image of the object due to fluorescence from the second display panel in response to the second light beam.

### BACKGROUND

Unless otherwise indicated herein, the approaches described in this section are not prior art to the claims in this application and are not admitted to be prior art by inclusion in this section.

In conventional depth-fused three-dimensional (DFD) display devices, light emitted from the backlight source passes through multiple liquid crystal display (LCD) panels before reaching the observer. Accordingly, when the light transmittance of one of the LCD panels (e.g., one located closer to the backlight source) is adjusted to be significantly lower than the other, the intensity of light passing through the LCD panels may be too weak to be detected by the observer. This problem may deteriorate the quality of the three-dimensional image as viewed by the observer.

### SUMMARY

Technologies are generally described for displaying a three-dimensional image of an object in a depth-fused three-dimensional (DFD) display device.

Various example devices configured to display a three-dimensional image of an object described herein may include one or more of a first light source, a first display panel, a second light source and/or a second display panel. The first light source may be configured to generate a first light beam based on a first input signal indicative of the object. The first display panel, including a transparent material added with one or more fluorescent materials, may be configured to receive the first light beam. Thus, the first display panel may form a first image of the object due to fluorescence from the first display panel in response to the first light beam. Also, the second light source may be configured to generate a second light beam based on a second input signal indicative of the object. The second display panel, including a transparent material added with one or more fluorescent materials, may be configured to receive the second light beam. Thus, the second display panel may form a second image of the object due to fluorescence from the second display panel in response to the second light beam.

For example, the first display panel may include a transparent substrate supporting emissive elements, such as fluorescent elements, plasma elements, cathodoluminescent elements, and the like. Some examples include apparatus and methods using first and second radiation beams to form the first and second images, such as first and second light beams, or first and second electron beams.

In some examples, methods for displaying a three-dimensional image of an object are described. Example methods may include generating, by a first light source, a first light beam based on a first input signal indicative of the object. The first light beam may be received by a first display panel including a transparent material added with one or more fluorescent materials, to form a first image of the object due to fluorescence from the first display panel in response to the first light beam. A second light beam may be generated by a second light source based on a second input signal indicative of the object. The second light beam may be received by a second display panel including a transparent material added with one or more fluorescent materials, to form a second image of the object due to fluorescence from the second display panel in response to the second light beam. In some examples, first and second radiation sources such as first and second electron beams may be used instead of the first and second light beams, respectively.

In some examples, a computer-readable storage medium is described that may be adapted to store a program operable by a display device to generate a three-dimensional image of an object. The processor may include various features as further described herein. The program may include one or more instructions for generating, by a first light source, a first light beam based on a first input signal indicative of the object, and receiving, by a first display panel including a transparent material added with one or more fluorescent materials, the first light beam to form a first image of the object due to fluorescence from the first display panel in response to the first light beam. The program may further include one or more instructions for generating, by a second light source, a second light beam based on a second input signal indicative of the object, and receiving, by a second display panel including a transparent material added with one or more fluorescent materials, the second light beam to form a second image of the object due to fluorescence from the second display panel in response to the second light beam. In some examples, first and second radiation sources such as first and second electron beams may be used instead of the first and second light beams, respectively.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 schematically shows a perspective view of an illustrative example display device configured to display a three-dimensional image of an object;

FIGS. 2A to 2C illustrate energy level diagrams of illustrative example fluorescent materials Tb³⁺, Eu³⁺, and Eu²⁺, respectively, used in a display device;

FIG. 3 schematically shows a cross-sectional view of an illustrative example display device configured to display a three-dimensional image of an object;

FIG. 4 schematically shows a block diagram of an illustrative example display device configured to display a three-dimensional image of an object;

FIG. 5 illustrates an example flow diagram of a method adapted to display a three-dimensional image of an object;

FIG. 6 shows a schematic block diagram illustrating an example computing system that can be configured to implement methods for displaying a three-dimensional image of an object; and

FIG. 7 illustrates computer program products that can be utilized to display a three-dimensional image of an object, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices and computer program products related to displaying a three-dimensional image of an object in a depth-fused three-dimensional (DFD) display device.

Briefly stated, technologies are generally described for displaying a three-dimensional image of an object. Example devices/systems described herein may use one or more of a first light source, a first display panel including a transparent material added with one or more fluorescent materials, a second light source and/or a second display panel including a transparent material added with one or more fluorescent materials. In various examples, a display device is described, where the device may be configured to generate a first light beam from the first light source based on a first input signal indicative of the object. The device may be further configured to receive the first light beam on the first display panel effectively to form a first image of the object due to fluorescence from the first display panel in response to the first light beam. Some example display devices may also be configured to generate a second light beam from the second light source based on a second input signal indicative of the object. The devices may be further configured to receive the second light beam on the second display panel effectively to form a second image of the object due to fluorescence from the second display panel in response to the second light beam.

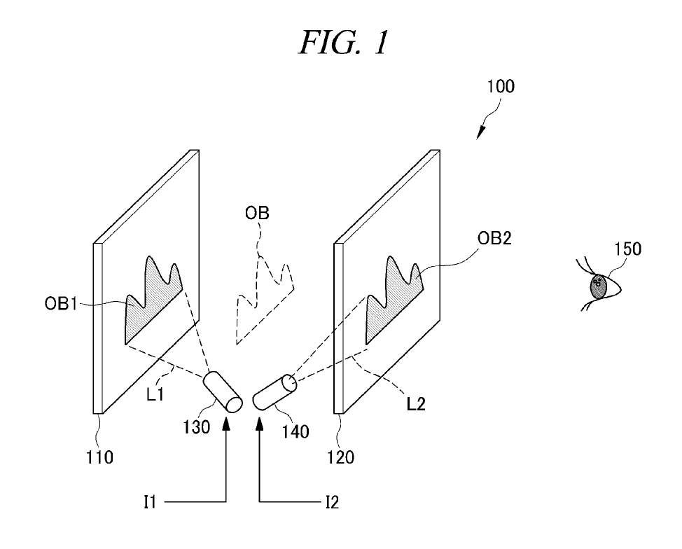

FIG. 1 schematically shows a perspective view of an illustrative example display device configured to display a three-dimensional image of an object, arranged in accordance with at least some embodiments described herein. As depicted, a display device 100 may include one or more of a first display panel 110, a second display panel 120, a first light source 130, and a second light source 140.

In operation, first light source 130 may be configured to generate a first light beam L1 based on a first input signal I1 representing an image of an object (e.g., an image of a three-dimensional object to be displayed by display device 100). Also, second light source 140 may be configured to generate a second light beam L2 based on a second input signal I2 representing the image of the object.

In some embodiments, first light source 130 and/or second light source 140 may generate a laser beam as first light beam L1 and/or second light beam L2, respectively. A light beam, such as a laser beam, may be a violet or UV light source, and in some examples a blue-violet light (including blue through violet wavelengths) may be used, for example a blue, violet, or UV wavelength shorter than the fluorescence emission. For example, first light source 130 and/or second light source 140 may be a helium-cadmium (HeCd) laser source having a wavelength of about 325 nm and a light intensity of less than about 100 mW. In some embodiments, first display panel 110 and second display panel 120 may be arranged at different depths from a viewing direction of an observer 150. As illustrated in FIG. 1, first display panel 110 may be arranged at a back side of display device 100 which is located farther than second display panel 120 from observer 150. On the other hand, second display panel 120 may be arranged at a front side of display device 100 which is closer than first display panel 110 to observer 150.

In some embodiments, each of first display panel 110 and second display panel 120 may include a transparent material added with one or more fluorescent materials. In some examples, the transparent material may be a glass material or a transparent plastic material. More specifically, the glass material may include at least one of borosilicate glass and phosphate glass. Also, the fluorescent material may include at least one of terbium ions (e.g., Tb³⁺), and europium ions (e.g., Eu³⁺, Eu²⁺). In various examples, the fluorescent materials may include at least one of amorphous barium titanate (BaTiO₃), amorphous lead titanate (PbTiO₃), amorphous strontium titanate (SrTiO₃), and amorphous potassium tantalate (KTaO₃). In some other examples, the glass material added with the fluorescent materials may include at least one of B₂O₃.CaO.SiO₂.La₂O₃:Tb³⁺, SiO₂.B₂O₃.BaO.ZnO:Eu³⁺, and P₂O₅.AlF₃.MgF₂.CaF₂.SrF₂.BaCl₂:Eu²⁺. Glasses and/or glass components may include borate glasses, silicate glasses (including borosilicate glasses, and the like), halide glasses (such as fluoride glasses, chloride glasses, and the like), or other glasses. Fluorescent materials may include a transition metal, such as a rare earth metal, which may exist in a cationic state in the material.

In some embodiments, when a light beam such as an ultraviolet laser beam is irradiated on first display panel 110 or second display panel 120, the fluorescent materials may be effective to emit light in response to the irradiation of the light beam. More specifically, an orbital electron in the fluorescent materials may be excited, by the irradiation of the light beam, from a current energy level to a higher energy level. Then, as the orbital electron relaxes to a ground energy level, a light having a wavelength corresponding to such energy level transition may be emitted from the fluorescent materials.

In some examples, a radiation beam such as an electron beam may be used in place of the light beam described in various examples herein. For example, in some examples, a system such as shown in FIG. 1 may include a first radiation source at 130 and/or a second radiation source at 140. The radiation source may be an electron beam generator, generating an electron beam that induces luminescence (in this example, cathodoluminescence) in a material. In such examples, the luminescent material (in this example, cathodoluminescent material) produces light in response to stimulation by the one or more electron beams. For example, an electron beam may be used in place of an ultraviolet laser beam in various examples described herein, and the luminescent materials may be the same or different than those used as fluorescent materials. Example cathodoluminescent material may comprise a “phosphor”, as the term is used in relation to cathode ray tubes (CRTs). Example materials include rare earth oxides and the like. In some examples, a first electron beam and/or second electron beam may be used instead of the first light beam L1 and/or second light beam L2, respectively.

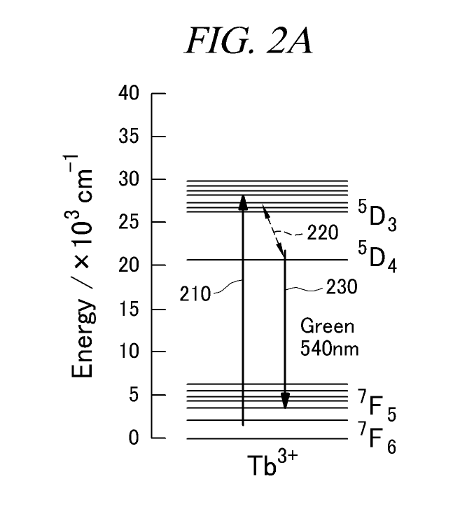

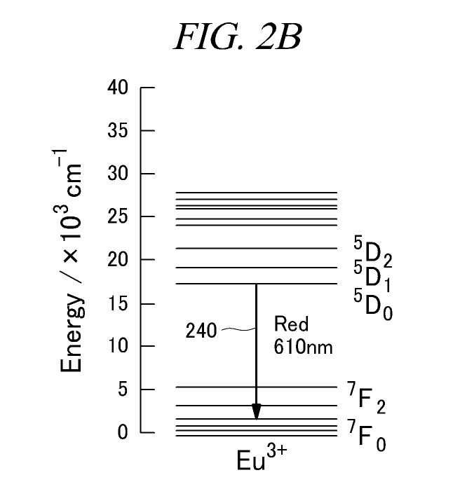

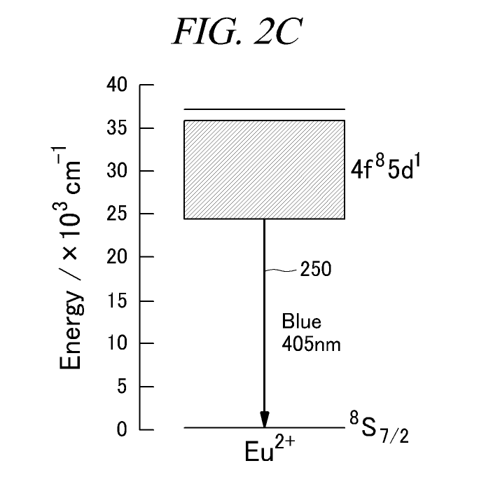

FIGS. 2A to 2C illustrate energy level diagrams of illustrative example fluorescent materials Tb³⁺, Eu³⁺, and Eu²⁺, respectively, used in a display device, arranged in accordance with at least some embodiments described herein.

As illustrated in FIG. 2A, in case of using terbium ions Tb³⁺ as a fluorescent material in a display panel such as first display panel 110 or second display panel 120, an f-orbital electron in the fluorescent material may be excited, by the irradiation of a light beam, from a current energy level to a higher energy level than ⁵D₄ or ⁵D₃ energy level (as indicated by a solid arrow 210). Then, as the orbital electron relaxes to ⁵D₄ or ⁵D₃ energy level (as indicated by a dotted arrow 220) and then relaxes to ⁷F₅ energy level (as indicated by a solid arrow 230). Accordingly, a green light having a wavelength of about 540 nm, which corresponds to the transition from ⁵D₄ energy level to ⁷F₅ energy level, may be emitted from the fluorescent material.

Further, as illustrated in FIG. 2B, in case of using europium ions Eu³⁺ as a fluorescent material in a display panel such as first display panel 110 or second display panel 120, an orbital electron excited by the irradiation of a light beam may exhibit a f-f energy level transition (e.g., ⁵D₀→⁷F₂, as indicated by a solid arrow 240). Accordingly, a red light having a wavelength of about 610 nm, which corresponds to such energy level transition, may be emitted from the fluorescent material. On the other hand, as illustrated in FIG. 2C, in case of using europium ions Eu²⁺ as a fluorescent material in a display panel such as first display panel 110 or second display panel 120, an orbital electron excited by the irradiation of a light beam may exhibit a different type of energy level transition (e.g., 4f⁸5d¹→⁸S_{7/2}, as indicated by a solid arrow 250). Accordingly, a blue light having a wavelength of about 405 nm, which corresponds to such energy level transition, may be emitted from the fluorescent material.

Referring back to FIG. 1, in some embodiments, first display panel 110 including one or more fluorescent materials may be configured to form an image OB1 of the object due to fluorescence from first display panel 110 in response to first light beam L1. Also, second display panel 120 including one or more fluorescent materials may be configured to form an image OB2 of the object due to fluorescence from second display panel 120 in response to second light beam L2. The light intensities of first light beam L1 and second light beam L2 may be adjusted, such that fluorescence ratio of first and second display panels 110 and 120 (e.g., light emission ratio of images OB1 and OB2) can also be adjusted accordingly. As a result, a depth of an object (represented by an image OB) perceived by the observer 150 may be determined according to the fluorescence ratio of first and second display panels 110 and 120, as explained in detail below.

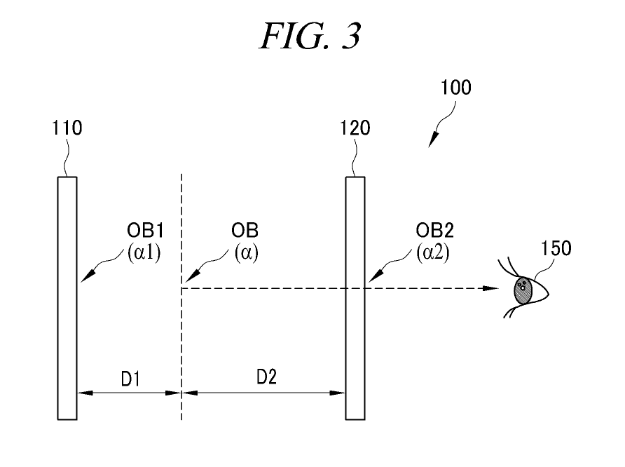

FIG. 3 schematically shows a cross-sectional view of an illustrative example display device configured to display a three-dimensional image of an object, arranged in accordance with at least some embodiments described herein.

As described above with reference to FIG. 1, image OB1 of the object may be displayed on first display panel 110 while image OB2 of the object may be displayed on second display panel 120. At this time, for example, the intensities of first and second light beams L1 and L2 may be adjusted (or modulated), respectively, based on first and second input signals I1 and I2. As a result, image OB1 displayed on first display panel 110 may have a light emission intensity (or luminance) α1 while image OB2 displayed on second display panel 120 may have a light emission intensity (or luminance) α2. In this case, observer 150 may perceive object OB as if it were displayed at a location between first and second display panels 110 and 120, in which the location may be determined according to the luminance ratio α1:α2. As illustrated in FIG. 3, object OB may be perceived as if it were positioned at a distance D1 from first display panel 110 and at a distance D2 from second display panel 120, where the distance ratio D1:D2 may be inversely proportional to the luminance ratio α1:α2.

In some embodiments, a luminance α of image OB (or the object represented by image OB) may be controlled to be substantially constant while adjusting luminance α1 and α2 of images OB1 and OB2, respectively, e.g., by adjusting the intensities of first and second light beams L1 and L2, such that observer 150 can perceive the object as being located at an intended depth.

In some examples, the intensities of first and second light beams L1 and L2 may be adjusted such that luminance α1 of image OB1 may be set to be substantially equal to luminance α of image OB to be perceived as being located substantially at an intended position, e.g., a position of first display panel 110, while luminance α2 of image OB2 may be set to be substantially zero. In this case, observer 150 may perceive the object (represented by image OB) as being located at the intended position. In some other examples, the intensities of first and second light beams L1 and L2 may be adjusted such that luminance α1 of image OB1 is decreased by a certain value while luminance α2 of image OB2 is increased by the same value. As a result, observer 150 may perceive the object as moving closer to observer 150. On the other hand, the intensities of first and second light beams L1 and L2 may be adjusted such that luminance α1 of image OB1 is increased by a certain value while luminance α2 of image OB2 is decreased by the same value. In this case, observer 150 may perceive the object as moving farther from observer 150.

According to the above embodiments, it is possible to display a three-dimensional image of an object in a DFD display device, such as display device 100, such that the object is perceived by an observer as being located at an intended depth, by adjusting the fluorescence ratio of multiple display panels, such as display panels 110 and 120, in the DFD display device.

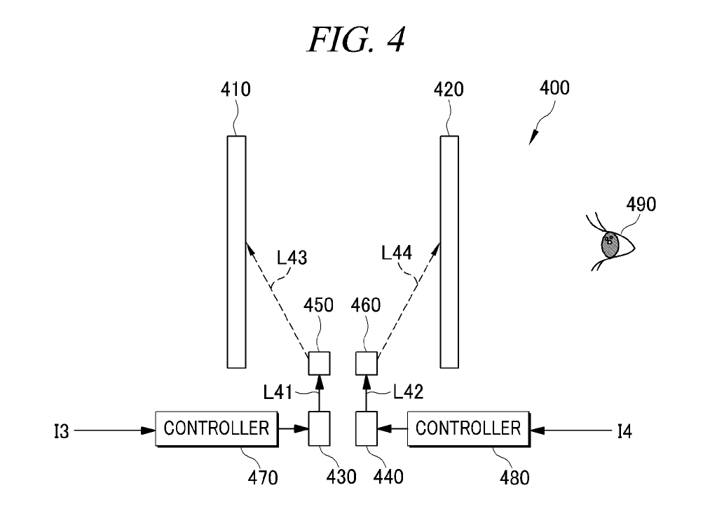

FIG. 4 schematically shows a block diagram of an illustrative example display device configured to display a three-dimensional image of an object, arranged in accordance with at least some embodiments described herein. As depicted, a display device 400 may include one or more of a first display panel 410, a second display panel 420, a first light source 430, and a second light source 440. Further, display device 400 may include a first scan mirror 450 and a first controller 470 respectively coupled to first light source 430, and a second scan mirror 460 and a second controller 480 respectively coupled to second light source 440. First light source 430 and second light source 440 each include a respective output that is coupled to corresponding inputs of first scan mirror 450 and second scan mirror 460. Also, first light source 430 and second light source 440 each include a respective input that is coupled to corresponding outputs of first controller 470 and second controller 480.

In some embodiments, first and second display panels 410 and 420 may have a similar configuration to first and second display panels 110 and 120, respectively. Also, first and second light sources 430 and 440 may have a similar configuration to first and second light sources 130 and 140, respectively. Accordingly, a detailed description of these elements 410 to 440 is omitted for the sake of explanation.

In operation, first scan mirror 450 may be configured to reflect a first light beam L41 from first light source 430 and generate a scan beam L43 to be irradiated on first display panel 410. Also, second scan mirror 460 may be configured to reflect a second light beam L42 from second light source 440 and generate a scan beam L44 to be irradiated on second display panel 420. First and second scan mirrors 450 and 460 may be configured to be magnetically actuated, electrostatically actuated, electrically actuated or electromagnetically actuated, wherein the actuation of first and second scan mirrors 450 and 460 are effective to steer scan beams L43 and L44, respectively (e.g., actuation may facilitate a change of the direction of scan beams L43 and L44 generated from first and second scan mirrors 450 and 460, respectively).

In some embodiments, first controller 470 may be configured to adjust intensity of a first light beam L41 from first light source 430 based on a first input signal I3. Also, second controller 480 may be configured to adjust intensity of a second light beam L42 from second light source 440 based on a second input signal I4. First and second input signals I3 and I4 may be pre-stored in a storage device (not shown) or transmitted from any other external device (e.g., a remote server coupled to display device 400 through a communication network).

In some embodiments, first display panel 410 may be configured to form an image (e.g., image OB1 as illustrated in FIGS. 1 and 3) of an object due to fluorescence from first display panel 410 in response to scan beam L43. Also, second display panel 420 may be configured to form another image (e.g., image OB2 as illustrated in FIGS. 1 and 3) of the object due to fluorescence from second display panel 420 in response to scan beam L44. The light intensities of first and second light beams L41 and L42 from first and second light sources 430 and 440, respectively, may be adjusted and thus the light intensities of scan beams L43 and L44 may be adjusted accordingly in the same manner as described above with reference to FIGS. 1 to 3. As a result, the fluorescence ratio of first and second display panels 410 and 420 (e.g., luminance ratio α1:α2 as illustrated in FIG. 3) may also be adjusted accordingly. Thus, the depth of the object (e.g., the object represented by image OB as illustrated in FIGS. 1 and 3) perceived by an observer 490 can be determined according to the fluorescence ratio of first and second display panels 410 and 420.

According to the above embodiments, the first light source (e.g., first light source 130 or 430) may generate an ultraviolet laser beam as the first light beam. Also, the second light source (e.g., second light source 140 or 440) may generate an ultraviolet laser beam as the second light beam. In some examples, the first light source and the second light source may be a helium-cadmium laser source having a wavelength of about 325 nm and a light intensity of less than about 100 mW.

According to some embodiments, a first radiation source (e.g., first light source 130 or 430, or an electron beam source) may generate a radiation beam, such as a light beam (for example, an ultraviolet, violet, or blue laser beam) or an electron beam as the first radiation beam. A second radiation source (e.g., second light source 140 or 440 or a second radiation beam source) may generate a second radiation beam (for example, a second ultraviolet, violet, or blue laser beam) or a second electron beam. In some examples, the first radiation source and/or the second radiation source may be a laser source, such as a helium-cadmium laser source having a wavelength of about 325 nm and a light intensity of less than about 100 mW. In some examples, the first radiation source and/or the second radiation source may comprise an electron beam source, for example an electron gun. An electron beam source may comprise an electron emitter, and associated electron optics such as an electron beam accelerator and/or electron beam steering device.

In some embodiments, the display devices (e.g., display devices 100 and 400) may further include a first scan mirror (e.g., first scan mirror 450) configured to reflect the first light beam (e.g., first light beam L1 or L41) to be irradiated on the first display panel (e.g., first display panel 110 or 410), and/or a second scan mirror (e.g., second scan mirror 460) configured to reflect the second light beam (e.g., second light beam L2 or L42) to be irradiated on the second display panel (e.g., second display panel 120 or 420). In some examples, the first scan mirror and the second scan mirror may be magnetically actuated, electrostatically actuated, or electromagnetically actuated.

In some embodiments, the display devices may further include a first controller (e.g., first controller 470) configured to adjust intensity of the first light beam from the first light source based on the first input signal (e.g., first input signal I3), and/or a second controller (e.g., second controller 480) configured to adjust intensity of the second light beam from the second light source based on the second input signal (e.g., second input signal I4).

In some embodiments, the transparent material may include one or more of a glass material and a transparent plastic material. In some examples, the glass material may include at least one of borosilicate glass and phosphate glass. Also, the fluorescent material may include at least one of terbium ions including Tb³⁺ and europium ions including Eu³⁺ or Eu²⁺. Alternatively, the fluorescent material may include at least one of amorphous barium titanate, amorphous lead titanate, amorphous strontium titanate, and amorphous potassium tantalate. In some other examples, the glass material added with the fluorescent material may include at least one of B₂O₃.CaO.SiO₂.La₂O₃:Tb³⁺, SiO₂.B₂O₃.BaO.ZnO:Eu³⁺, and P₂O₅.AlF₃.MgF₂.CaF₂.SrF₂.BaCl₂: Eu²⁺.

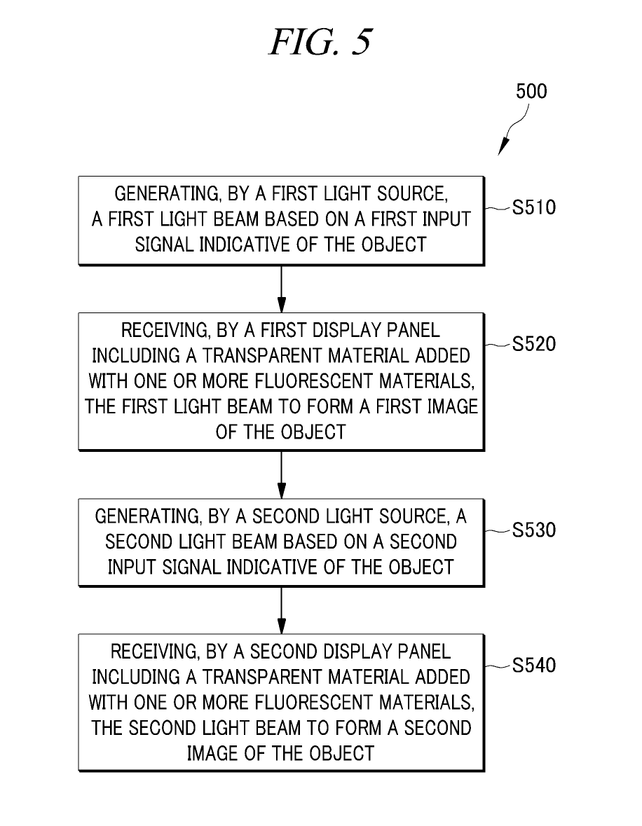

FIG. 5 illustrates an example flow diagram of a method adapted to display a three-dimensional image of an object in accordance with at least some embodiments described herein. An example method 500 in FIG. 5 may be implemented using, for example, a computing device including a processor adapted to display a three-dimensional image of an object.

Method 500 may include one or more operations, actions, or functions as illustrated by one or more of blocks S510, S520, S530, and/or S540. Although illustrated as discrete blocks, various blocks may be divided into additional blocks, combined into fewer blocks, or eliminated, depending on the desired implementation. In some further examples, the various described blocks may be implemented as a parallel process instead of a sequential process, or as a combination thereof. Method 500 may begin at block 5510, “GENERATING, BY A FIRST LIGHT SOURCE, A FIRST LIGHT BEAM BASED ON A FIRST INPUT SIGNAL INDICATIVE OF THE OBJECT.”

At block 5510, a first light beam may be generated, by a first light source, based on a first input signal indicative of the object. As depicted in FIG. 1, in some embodiments, first light source 130 may generate first light beam L1 based on first input signal I1 representing an image of the object. In some embodiments, first light source 130 may generate an ultraviolet laser beam as first light beam L1. Block 5510 may be followed by block S520, “RECEIVING, BY A FIRST DISPLAY PANEL INCLUDING A TRANSPARENT MATERIAL ADDED WITH ONE OR MORE FLUORESCENT MATERIALS, THE FIRST LIGHT BEAM TO FORM A FIRST IMAGE OF THE OBJECT.”

At block S520, the first light beam may be received, by a first display panel including a transparent material added with one or more fluorescent materials, to form a first image of the object due to fluorescence from the first display panel in response to the first light beam. As illustrated in FIG. 1, in some embodiments, first display panel 110 may include a transparent material added with one or more fluorescent materials such as terbium ions (e.g., Tb³⁺), and europium ions (e.g., Eu³⁺, Eu²⁺). When a light beam (e.g., an ultraviolet laser beam) is irradiated on first display panel 110, the fluorescent materials may be effective to emit light in response to the irradiation of the light beam. Thus, first display panel 110 including the fluorescent materials may form image OB1 of the object due to fluorescence from first display panel 110 in response to first light beam L1.

In some embodiments, the first light beam may be reflected, by a first scan mirror, to be irradiated on the first display panel. Further, the intensity of the first light beam from the first light source may be adjusted, by a first controller, based on the first input signal. For example, as illustrated in FIG. 4, first scan mirror 450 may reflect first light beam L41 from first light source 430 and generate scan beam L43 to be irradiated on first display panel 410. Also, first controller 470 may adjust intensity of first light beam L41 from first light source 430 based on first input signal I3. Block S520 may be followed by block S530, “GENERATING, BY A SECOND LIGHT SOURCE, A SECOND LIGHT BEAM BASED ON A SECOND INPUT SIGNAL INDICATIVE OF THE OBJECT.”

At block S530, a second light beam may be generated, by a second light source, based on a second input signal indicative of the object. As illustrated in FIG. 1, in some embodiments, second light source 140 may be configured to generate second light beam L2 based on second input signal I2 representing the image of the object. In some embodiments, second light source 140 may generate an ultraviolet laser beam as second light beam L2. Block S530 may be followed by block S540, “RECEIVING, BY A SECOND DISPLAY PANEL INCLUDING A TRANSPARENT MATERIAL ADDED WITH ONE OR MORE FLUORESCENT MATERIALS, THE SECOND LIGHT BEAM TO FORM A SECOND IMAGE OF THE OBJECT.”

At block S540, the second light beam may be received, by a second display panel including a transparent material added with one or more fluorescent materials, to form a second image of the object. As illustrated in FIG. 1, in some embodiments, second display panel 120 may include a transparent material added with one or more fluorescent materials such as terbium ions (e.g., Tb³⁺), and europium ions (e.g., Eu³⁺, Eu²⁺). When a light beam (e.g., an ultraviolet laser beam) is irradiated on second display panel 120, the fluorescent materials may be effective to emit light in response to the irradiation of the light beam. Thus, second display panel 120 including the fluorescent materials may form image OB2 of the object due to fluorescence from second display panel 120 in response to second light beam L2.

In some embodiments, the second light beam may be reflected, by a second scan mirror, to be irradiated on the second display panel. Further, the intensity of the second light beam from the second light source may be adjusted, by a second controller, based on the second input signal. For example, as illustrated in FIG. 4, second scan mirror 460 may reflect first light beam L42 from first light source 440 and generate scan beam L44 to be irradiated on second display panel 420. Also, second controller 480 may adjust intensity of second light beam L42 from second light source 440 based on second input signal I4.

One skilled in the art will appreciate that, for this and other methods disclosed herein, the functions performed in the methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

In some examples, one or more electron beams may be used instead of the light beams discussed in relation to FIG. 5. First and second electron beams may be generated, by a first and second electron beam sources respectively, based on first and second input signals, respectively, indicative of the object. The first electron beam may be received, by a first display panel including a transparent material added with one or more luminescent materials to form a first image of the object due to luminescence from the first display panel in response to the first electron beam. The second electron beam may be received by a second display panel including a transparent material added with one or more luminescent materials to form a second image of the object. In some embodiments, the first and/or second electron beams may be reflected and/or deflected, by a first scan device such as a mirror or deflector, to be irradiated on the first and/or second display panel, respectively. Luminescent materials include cathodoluminescent materials. In some examples, a light source, such as a first and/or second light source, may be a solid state light source, such as a semiconductor light source. A light source may be a light emitting diode (LED) or a laser. In some examples, a light source may be a semiconductor laser, such as a nitride semiconductor laser, such as a GaN or AlGaN laser.

In some examples, a transparent material added with one or more luminescent materials may comprise a sheet, such as a glass sheet or a plastic sheet, for example a transparent sheet comprising a luminescent material as a dopant or other additive. A luminescent material may be approximately uniformly dispersed in a transparent material, or in some examples may be concentrated in regions and/or layered. In some examples, a display panel comprises a transparent material that is substantially transparent to visible light, or over the color range of the display. For example, a transparent material may be an optically transparent plastic, or a glass, such as an inorganic glass, for example a silicate glass, such as a borosilicate glass. In some examples, a transparent material added with one or more luminescent materials may comprise luminescent materials included in a transparent material matrix, for example in the form of a dopant or additive dispersed through the transparent material, for example as one or more added molecular species, inorganic dopants (such as one or more metal ions, such as transition metal ions), semiconductor particles (such as quantum dots), and the like. In some examples, a transparent material added with one or more luminescent materials may include a transparent material supporting a luminescent material, for example in the form of a patterned surface layer, for example as patches of a luminescent material arranged at intervals over the surface of a transparent sheet. In some examples, a transparent material added with one or more luminescent materials may comprise a composite, mixture, or other combination of the transparent material and the one or more luminescent materials. In some examples, the luminescent material may be a photoluminescent material (such as a fluorescent material), a cathodoluminescent material, an electroluminescent material, a phosphor (either in the sense of an electron beam stimulated luminescent material, or other UV-visible stimulated luminescent material), and the like. In some examples, a transparent material and luminescent material may be chemically combined (for example, a generally transparent material including a luminescent chemical group, such as a transparent polymer with a fluorescent side chain moiety), or otherwise included in a single material.

In some examples, a display device configured to display a three-dimensional image of an object comprises a first light source configured to generate a first light beam based on a first input signal indicative of the object, a first display panel including a first transparent material and a first luminescent material configured to receive the first light beam, a second light source configured to generate a second light beam based on a second input signal indicative of the object, and a second display panel including a second transparent material and a second luminescent material configured to receive the second light beam. The first display panel is effective to form a first image of the object due to first luminescence from the first display panel in response to the first light beam, and the second display panel is effective to form a second image of the object due to second luminescence from the second display panel in response to the second light beam. The first light source may be configured to generate a first laser beam as the first light beam, and the second light source may be configured to generate a second laser beam as the second light beam. The laser beams may be ultraviolet or violet laser beams, and the light sources may be ultraviolet or violet lasers. In some examples, a plurality of lasers may be used in association with each display panel, for example to improve the refresh rate of each display panel. In some examples, the first transparent material and/or the second transparent material may be in the form of a transparent sheet. In some examples, the luminescent material, such as a fluorescent material, may be doped into or otherwise dispersed through or mixed with the transparent material. The first and/or second transparent material may form a transparent matrix in which the luminescent material is included, for example as a dopant, additive, component, and the like. The first and/or second transparent material may be in the form of a transparent sheet, such as a glass sheet, plastic sheet, and the like. The first and/or second display panel may be generally rigid, and in some examples may be flexible. In some examples, the first and second display panels may be generally planar and generally parallel, and in some examples may have a generally uniform spacing even if not planar, for example as spaced apart curved panels. The first and/or the second luminescent material, such as a fluorescent material, may include a transition metal, for example a rare earth metal, for example in the form of an ionic (e.g. cationic) dopant. A luminescent material may be added into a transparent material, and/or luminescent material may be a patterned film supported by the transparent material, for example in the form of a patterned film, for example as patches supported by the transparent layer, and for example as an array of patches. In some examples, a film need not be patterned, with spatial resolution provided by the light beam. There may be a plurality of species of luminescent material added to any display panel, for example allowing the generation of colors sufficient to provide a color display, for example luminescent (e.g. fluorescent) materials that generate red, green, or blue luminesce on stimulation by the beam. There may be a concentration gradient of luminescent material in a transparent material, for example allowing depth and/or lateral position dependent color emission. In some examples, a transparent sheet may have a thickness in the range 0.1 mm-10 cm, though this is not restrictive. In some examples, a multilayer structure may be used, for example including a transparent material/luminescent material/transparent material structure, and there may be a plurality of luminescent layers each with different color emission.

A light beam, generated by the light source, may be controlled by a scan mirror so that the light beam scans across a display panel. The scanned light beam may be referred to as a scan beam. The scan beam may be rastered across the display. The light beam may be a coherent light beam generated by a laser. A beam scanner may comprise one or more mirrors, and/or one or more electro-optic devices configured to steer a light beam based on an electrical control signal. Similarly, an electron beam may be scanned across the display panel with which it is associated, for example by an electron beam steering device. An electron beam steering device may comprise one or more metal plates to which an electric potential may be applied. An signal representative of an object (or part thereof) may encode a perceived position of the object as between the first and second panels, and the electrical control signal sent to respective light sources may be configured to generate an appropriate emission intensity from each panel so that the object is perceived to be located between the panels, as viewed by a person.

In some examples, a display panel may include a transparent material supporting or including a fluorescent material. Examples include a transparent medium, such as glass or plastic, doped with a fluorescent dopant, such as a transition metal, such as a rare earth metal, which may be in an ionized state. In some examples, a transparent sheet may support one or more patterned fluorescent materials. In some examples, other fluorescent materials may be used, such as fluorescent polymers. In some examples, a single glass substrate may be doped with fluorescent ions in a patterned fashion, so as to have localized regions of doping. In other examples, an array of fluorescent elements may be supported on a transparent substrate. For example, the transparent substrate may be glass or polymer, and the fluorescent elements may be doped glass or polymer.

In some examples, a display panel may include a transparent substrate and fluorescent materials deposited thereon, for example as part of a patterned fluorescent film supported by the substrate. Different portions of the film may fluoresce at different wavelengths when the light source is incident on the portions.

In some examples using a light beam, a display panel may include non-fluorescent regions, such as scattering regions. For example, a blue light source may be used to generate blue light emitted by the display panel by a non-fluorescence mechanism such as scattering, and fluorescent materials may be used to obtain longer-wavelength light such as red and green light. For example, the front-most panel of a display, as perceived by a viewer, may be configured in such a way. Any fluorescence generated by blue emission in neighboring regions of the panel may be minimal, for example due to the relatively low intensity or optical blocking elements around pixel regions.

In some examples, one or more luminescent materials (such as cathodoluminescent materials) may be used in place of fluorescent materials in examples described herein.

In some examples, a light source may be located outside of the region between display panels, so as to not block viewing of a display panel. A beam control system may be configured to account for the arrangement used.

In some examples, one or more light sources may be located behind a first panel, for example behind the rearmost panel of an example display, as perceived by a viewer of the display. A light source may be located to excite fluorescence from the first panel, without blocking view of the panel.

In some examples, a radiation beam such as a light beam may be expanded and then focused onto a panel. For example, a light beam may pass through one or more panels as a relatively broad beam, then be focused or approximately focused on another panel.

In some examples, there may be one light source per panel. For example, a single light beam may be rastered over a panel. The intensity of the light beam may be controlled so that the beam intensity as the beam is incident at a particular position on the panel induces an emission of desired intensity at that position. The emission wavelength may also be determined by the position of the light beam on the panel, for example corresponding to a position of a fluorescent element of particular wavelength emission. In some examples, there may be a plurality of light sources per panel. In some examples, a single radiation source may address a plurality of panels, for example scanning across each of a plurality of panels in a sequential or interlaced way.

In some examples, the light source may be modulated, for example using pulse width modulation, amplitude modulation, and the like, to control the emission intensity as the light.

In some examples, there may be more than two panels in the display. For example, three panels may be considered as two pairs of panels with the center panel common to the two pairs. A perceived image may be located between either of the pairs of panels using the methods described herein for a single pair of panels. This approach may be extended to an arbitrary number of panels.

Some example displays do not include a liquid crystal panel, so that the light attenuation problems of LCD panels are avoided. Some example displays do not include a polarizer, so that the light absorbing properties of polarizers are avoided. Some example displays do not require a separate backlight, in addition to the emissive elements, such that one or more of light wastage, unnecessary heat generation, and unnecessary power consumption of a backlight is avoided.

In some examples, a light source is not required and emission is obtained using electroluminescent elements. For example, at least one panel may comprise electroluminescent elements such as light emitting diodes (LEDs), such as semiconductor LEDs or organic light emitting diodes (OLEDS), or other electroluminescent light emitting devices.

In some examples, a panel may include a transparent substrate (such as glass or plastic), an array of electroluminescent elements (for example, LEDs), and a suitable arrangement of transparent electrodes configured to drive the electroluminescent elements. For example, using a pair of transparent OLED panels, an image may appear to be located between the two panels by appropriate control of the relative emissive intensity of corresponding pixels on the two panels. For planar panels, it may be considered that panels are be parallel to an x-y plane and displaced along the z-direction, so that corresponding pixels of different panels have similar x-y coordinates but are relatively displaced along the z-direction. Appropriate control of the emissive intensity of corresponding pixels of different panels allows a perceived image depth to have a z-coordinate (depth) located between that of the corresponding pixels.

In some examples, an improved display is an improved depth fused three-dimensional (DFD) display device which can be used to display three-dimensional images of objects, such that an observer can view the objects as if they are positioned at different depths in a three-dimensional space. A DFD may include two or more display panels (such as fluorescent panels or other emissive panels) provided at different depths as viewed from an observer. Light emission from the display panels may be respectively adjusted such that an observer can view a three-dimensional image of the object formed due to the emission differences from the display panels. In some examples, no liquid crystal display panels are used, reducing the light attenuation problems and polarization issues associated with such displays.

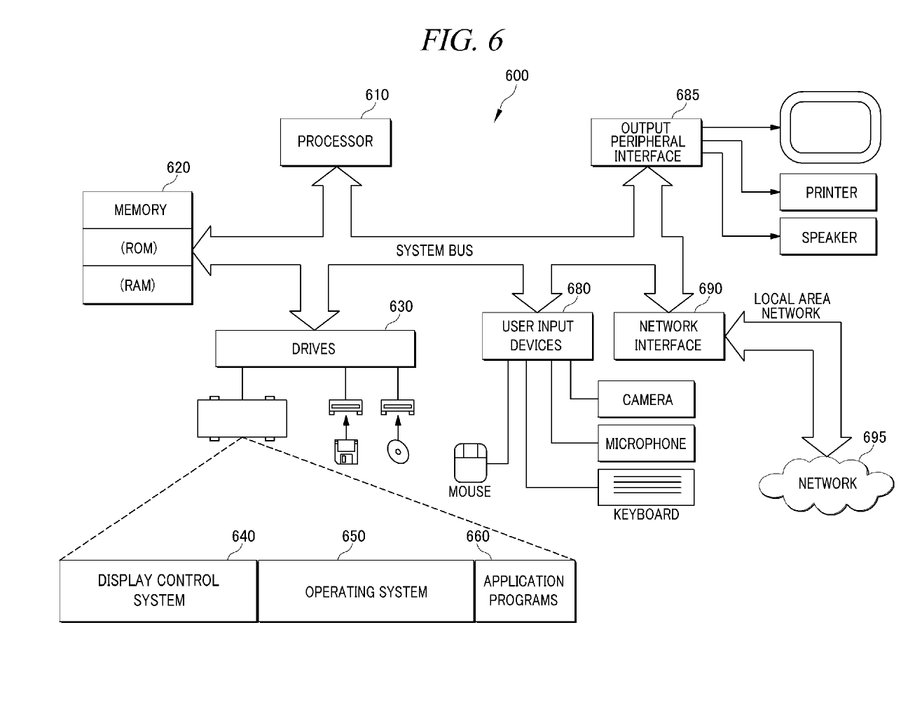

FIG. 6 shows a schematic block diagram illustrating an example computing system that can be configured to implement methods for displaying a three-dimensional image of an object, arranged in accordance with at least some embodiments described herein. As depicted in FIG. 6, a computer 600 may include a processor 610, a memory 620 and one or more drives 630. Computer 600 may be implemented as a conventional computer system, an embedded control computer, a laptop, or a server computer, a mobile device, a set-top box, a kiosk, a vehicular information system, a mobile telephone, a customized machine, or other hardware platform.

Drives 630 and their associated computer storage media may provide storage of computer readable instructions, data structures, program modules and other data for computer 600. Drives 630 may include a display control system 640, an operating system (OS) 650, and application programs 660. Display control system 640 may be adapted to control a display device in such a manner as described above with respect to FIGS. 1 to 5.

Computer 600 may further include user input devices 680 through which a user may enter commands and data. Input devices can include an electronic digitizer, a camera, a microphone, a keyboard and pointing device, commonly referred to as a mouse, trackball or touch pad. Other input devices may include a joystick, game pad, satellite dish, scanner, or the like.

These and other input devices can be coupled to processor 610 through a user input interface that is coupled to a system bus, but may be coupled by other interface and bus structures, such as a parallel port, game port or a universal serial bus (USB). Computers such as computer 600 may also include other peripheral output devices such as display devices, which may be coupled through an output peripheral interface 685 or the like.

Computer 600 may operate in a networked environment using logical connections to one or more computers, such as a remote computer coupled to a network interface 690. The remote computer may be a personal computer, a server, a router, a network PC, a peer device or other common network node, and can include many or all of the elements described above relative to computer 600.

Networking environments are commonplace in offices, enterprise-wide area networks (WAN), local area networks (LAN), intranets, and the Internet. When used in a LAN or WLAN networking environment, computer 600 may be coupled to the LAN through network interface 690 or an adapter. When used in a WAN networking environment, computer 600 typically includes a modem or other means for establishing communications over the WAN, such as the Internet or a network 695. The WAN may include the Internet, the illustrated network 695, various other networks, or any combination thereof. It will be appreciated that other mechanisms of establishing a communications link, ring, mesh, bus, cloud, or network between the computers may be used.

In some embodiments, computer 600 may be coupled to a networking environment. Computer 600 may include one or more instances of a physical computer-readable storage medium or media associated with drives 630 or other storage devices. The system bus may enable processor 610 to read code and/or data to/from the computer-readable storage media. The media may represent an apparatus in the form of storage elements that are implemented using any suitable technology, including but not limited to semiconductors, magnetic materials, optical media, electrical storage, electrochemical storage, or any other such storage technology. The media may represent components associated with memory 620, whether characterized as RAM, ROM, flash, or other types of volatile or nonvolatile memory technology. The media may also represent secondary storage, whether implemented as storage drives 630 or otherwise. Hard drive implementations may be characterized as solid state, or may include rotating media storing magnetically encoded information.

Processor 610 may be constructed from any number of transistors or other circuit elements, which may individually or collectively assume any number of states. More specifically, processor 610 may operate as a state machine or finite-state machine. Such a machine may be transformed to a second machine, or specific machine by loading executable instructions. These computer-executable instructions may transform processor 610 by specifying how processor 610 transitions between states, thereby transforming the transistors or other circuit elements constituting processor 610 from a first machine to a second machine. The states of either machine may also be transformed by receiving input from user input devices 680, network interface 690, other peripherals, other interfaces, or one or more users or other actors. Either machine may also transform states, or various physical characteristics of various output devices such as printers, speakers, video displays, or otherwise.

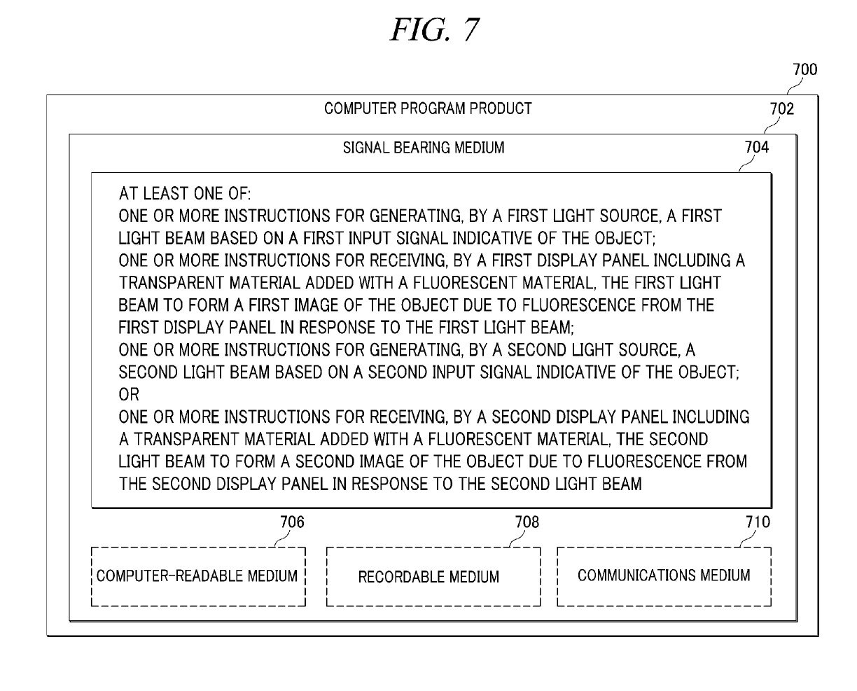

FIG. 7 illustrates computer program products 700 that can be utilized to operate a display device in accordance with at least some embodiments described herein. Program product 700 may include a signal bearing medium 702. Signal bearing medium 702 may include one or more instructions 704 that, when executed by, for example, a processor, may provide the functionality described above with respect to FIGS. 1 to 5. By way of example, instructions 704 may include at least one of: one or more instructions for generating, by a first light source, a first light beam based on a first input signal indicative of the object; one or more instructions for receiving, by a first display panel including a transparent material added with a fluorescent material, the first light beam to form a first image of the object due to fluorescence from the first display panel in response to the first light beam; one or more instructions for generating, by a second light source, a second light beam based on a second input signal indicative of the object; or one or more instructions for receiving, by a second display panel including a transparent material added with a fluorescent material, the second light beam to form a second image of the object due to fluorescence from the second display panel in response to the second light beam. Thus, for example, referring to FIGS. 1 to 4, display device 100 or 400 may undertake one or more of the blocks shown in FIG. 5 in response to instructions 704.

In some implementations, signal bearing medium 702 may encompass a computer-readable medium 706, such as, but not limited to, a hard disk drive, a Compact Disc (CD), a Digital Video Disk (DVD), a digital tape, memory, etc. In some implementations, signal bearing medium 702 may encompass a recordable medium 708, such as, but not limited to, memory, read/write (R/W) CDs, R/W DVDs, etc. In some implementations, signal bearing medium 702 may encompass a communications medium 710, such as, but not limited to, a digital and/or an analog communication medium (e.g., a fiber optic cable, a waveguide, a wired communications link, a wireless communication link, etc.). Thus, for example, program product 700 may be conveyed to one or more modules of display device 100 or 400 by an RF signal bearing medium 702, where the signal bearing medium 702 is conveyed by a wireless communications medium 710 (e.g., a wireless communications medium conforming with the IEEE 802.11 standard).

The present disclosure is not to be limited in terms of the particular embodiments described in this application, which are intended as illustrations of various aspects. Many modifications and variations may be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A display device configured to display a three-dimensional image of an object, the display device comprising:
a first radiation source configured to generate a first radiation beam based on a first input signal indicative of the object;
a first display panel, including a first transparent material added with a first luminescent material, configured to receive the first radiation beam, wherein the first display panel is effective to form a first image of the object due to first luminescence from the first display panel in response to the first radiation beam;
a second radiation source configured to generate a second radiation beam based on a second input signal indicative of the object; and
a second display panel, including a second transparent material added with a second luminescent material, configured to receive the second radiation beam, wherein the second display panel is effective to form a second image of the object due to second luminescence from the second display panel in response to the second radiation beam.

2. The display device of claim 1, wherein:
the first radiation source is a first electron beam source;
the first radiation beam is a first electron beam;
the second radiation source is a second electron beam source; and
the second radiation beam is a second electron beam.

3. The display device of claim 1, wherein:
the first radiation source is a first light source;
the first radiation beam is a first light beam;
the second radiation source is a second light source; and
the second radiation beam is a second light beam.

4. The display device of claim 3, wherein the first light source is configured to generate a first ultraviolet laser beam as the first light beam, and the second light source is configured to generate a second ultraviolet laser beam as the second light beam.

5. The display device of claim 3, wherein the first light source and the second light source are each a helium-cadmium laser source having a wavelength of about 325 nm and a light intensity of less than about 100 mW.

6. The display device of claim 3, further comprising:
a first scan mirror configured to reflect the first light beam to be irradiated on the first display panel; and
a second scan mirror configured to reflect the second light beam to be irradiated on the second display panel.

7. The display device of claim 6, wherein the first scan mirror and the second scan mirror are magnetically actuated, electrostatically actuated, or electromagnetically actuated.

8. The display device of claim 1, further comprising:
a first controller configured to adjust intensity of the first radiation beam from the first radiation source based on the first input signal; and
a second controller configured to adjust intensity of the second radiation beam from the radiation light source based on the second input signal.

9. The display device of claim 1, wherein the first transparent material comprises a glass material or a transparent plastic material.

10. The display device of claim 9, wherein the first transparent material comprises one or more materials selected from the group consisting of borosilicate glass and phosphate glass.

11. The display device of claim 1, wherein the first luminescent material comprises one or more materials selected from the group consisting of terbium ions including Tb3+ and europiumions including Eu3+ or Eu2+.

12. The display device of claim 1, wherein the first luminescent material comprises one or more materials selected from the group consisting of amorphous barium titanate, amorphous lead titanate, amorphous strontium titanate, and amorphous potassium tantalate.

13. The display device of claim 1, wherein the first transparent material added with the first luminescent material comprises one or more materials selected from the group consisting of B2O3.CaO.SiO2.La2O3:Tb3+, SiO2.B2O3.BaO.ZnO:Eu3+, and P2O5.AlF3.MgF2.CaF2.SrF2.BaCl2: Eu2+.

14. The display device of claim 1, wherein the first luminescent material is a first fluorescent material.

15. The display device of claim 1, wherein the first luminescent material is a first cathodoluminescent material.

16. A method for displaying a three-dimensional image of an object, comprising:
generating, by a first light source, a first light beam based on a first input signal indicative of the object;
receiving, by a first display panel including a transparent material added with a first fluorescent material, the first light beam to form a first image of the object due to fluorescence from the first display panel in response to the first light beam;
generating, by a second light source, a second light beam based on a second input signal indicative of the object; and
receiving, by a second display panel including a transparent material added with a second fluorescent material, the second light beam to form a second image of the object due to fluorescence from the second display panel in response to the second light beam.

17. The method of claim 16, wherein generating the first light beam comprises generating, by the first light source, an ultraviolet laser beam as the first light beam, and generating the second light beam comprises generating, by the second light source, an ultraviolet laser beam as the second light beam.

18. The method of claim 16, further comprising:
reflecting, by a first scan mirror, the first light beam to be irradiated on the first display panel; and
reflecting, by a second scan mirror, the second light beam to be irradiated on the second display panel.

19. The method of claim 16, further comprising:
adjusting, by a first controller, intensity of the first light beam from the first light source based on the first input signal; and
adjusting, by a second controller, intensity of the second light beam from the second light source based on the second input signal.

20-23. (canceled)

24. A display device configured to display a three-dimensional image of an object, the display device comprising:
a first light source configured to generate a first light beam based on a first input signal indicative of the object;
a first display panel, including a first transparent material and a first luminescent material, configured to receive the first light beam, wherein the first display panel is effective to form a first image of the object due to first luminescence from the first display panel in response to the first light beam;
a second light source configured to generate a second light beam based on a second input signal indicative of the object; and
a second display panel, including a second transparent material and a second luminescent material, configured to receive the second light beam, wherein the second display panel is effective to form a second image of the object due to second luminescence from the second display panel in response to the second light beam.

25. The display device of claim 24, wherein the first light source is configured to generate a first laser beam as the first light beam, and the second light source is configured to generate a second laser beam as the second light beam.

26. The display device of claim 24, wherein the first light source and the second light source are both ultraviolet emission lasers.

27. The display device of claim 24, wherein the first display panel comprises a first transparent sheet comprising the first transparent material, and a second transparent sheet comprising the second transparent material.

28. The display device of claim 24, wherein the first transparent material is a glass.

29. The display device of claim 24, wherein the first transparent material is a plastic.

30. The display device of claim 24, wherein the first luminescent material is a fluorescent material.

31. The display device of claim 24, wherein the first luminescent material is a transition metalion.

32. The display device of claim 24, wherein the first luminescent material is a rare earth metalion.

33. The display device of claim 24, wherein the first luminescent material is added into the first transparent material, wherein the first transparent material forms a transparent matrix for the first luminescent material.

34. The display device of claim 24, wherein the first transparent material supports the first luminescent material on a surface of the first transparent material.

35. The display device of claim 24, comprising a patterned film of the first luminescent material supported by a surface of the first transparent material.
